(19) United States
(12) Patent Application Publication
(10) Pub. No.: US 2006/0146801 A1
(43) Pub. Date: Jul. 6, 2006

(54) Method and system control for the setup of an IP telephony connection

(76) Inventors: Udo Kayser, Wuppertal (DE); Frank Rodewald, Bedburg (DE)

Correspondence Address: SHERIDAN ROSS P.C., 1560 BROADWAY, SUITE 1200, DENVER, CO, 80202, US

(21) Appl. No.: 11/268,273

(22) Filed: Nov. 4, 2005

(30) Foreign Application Priority Data
Nov. 5, 2004 (DE) 10 2004 053 928.6

(51) Int. Cl. H04J 3/22; H04L 12/56; H04L 12/66; H04L 12/28; H04L 12/26; H04J 3/16; H04L 1/00

(52) U.S. Cl. 370/352; 370/229; 370/465; 370/395.2

(57) ABSTRACT

The invention relates to a method and system control for the setup of an IP telephony connection between an original terminal and a destination terminal in an IP network over a gateway of a branch exchange. To increase the availability of the overall system for each EP terminal and to enhance in this way the voice quality of the IP-telephony connection, the setup of a connection between the original terminal and a first gateway is effected, according to the invention, by means of a list of IP addresses, a connection between the first gateway and a second gateway is set up by a system control of the branch exchange, and a connection between the second gateway and the destination terminal is effected by the second gateway, the setup of the connection between the first gateway and the second gateway through the system control comprising the determination of a gateway with spare traffic-handling capacities among the several gateways of the branch exchange and the definition of this gateway as being the second gateway.

### FIELD

The invention relates to a method and system control for the setup of an IP telephone connection between terminals in an IP network, controlled by a branch exchange which is also connected to the IP network. A branch exchange comprises at least one gateway, and several terminals are allocated to one gateway.

### BACKGROUND

In the internet telephony over IP networks (voice over IP networks), branch exchanges and other technical devices (terminals) are connected with each other through special gateways over the Internet or an Intranet, so that it is possible to make calls over the IP network from a conventional telephone to another conventional telephone using the normal telephone number and possibly a special Internet access code. For the user of the conventional telephone, the utilization of the IP network is hidden.

According to the state of the art, in the Internet telephony (voice over IP, VoIP), an IP terminal functioning according to an Internet protocol (IP) (IP terminal) is allocated, like every conventional ISDN terminal, in addition to its IP address, a directory number assigned within the branch exchange to which this terminal is allocated, through a directory-number plan, to a fixed hardware address (HWA). The Internet-telephony interface (VoIP board, applicant's product name, here synonymous to gateway) behaves, as seen by the (software for the) exchange, like an assembly with non IP terminals, i.e., the terminal is fixedly allocated to an HWA. This is realized by converting the HWA transmitted, upon setup of the connection, to the gateway (VoIP board) into an IP address with which the gateway (VoIP board) sets up the connection over the IP network (LAN) to the IP terminal. In the opposite direction (i.e. as seen by the terminal setting up the connection), the terminal sets up, over the IP address of the gateway stored in the terminal, the connection to this gateway and thus to the branch exchange. That mans that there is an unambiguous allocation between terminal and gateway.

As the connection is in general switched over two different gateways (VoIP boards), the data flow (media stream) must as a rule be switched over a switching matrix of the branch exchange. In the switching matrix or switching network of the branch exchange, incoming and outgoing lines or channels are connected with each other in conformity with control data.

When connecting terminals over two different gateways (VoIP boards), there are two transcoding operations, namely, on the one hand, the transcoding from IP coding to ISDN coding and, on the other hand, the transcoding from ISDN coding to IP coding. Only if the calling and the called terminals are allocated to the same VoIP board, will it be possible to switch the data flow (media stream) on the assembly, i.e. without the switching matrix of the branch exchange, and the transcodings are omitted.

Furthermore, the number of IP terminals (IP phones) allocated to one gateway (VoIP board) is often clearly larger than the capacity of a gateway (VoIP board) for the control of connections.

### SUMMARY

It is the object of the invention to create a method and a system control with which the above-mentioned shortcomings of the prior art can be avoided and the availability of the overall system for each IP terminal and thus the voice quality of the IP-telephony connection can be enhanced.

This object is achieved according to the invention through the described method and the system control, respectively. Preferred embodiments of the invention are the subject matter of the dependent claims.

The idea of the invention is based on a flexible, i.e. connection-related, allocation of IP terminals to gateways (VoIP boards), in order to avoid the switching of the data flow over the switching matrix of the branch exchange. For this purpose, all gateways (VoIP boards) of one branch exchange are combined in a pool. In addition, all IP terminals allocated to this branch exchange are allocated, through the directory-number plan, to one pseudo hardware address. This pseudo hardware address has the same format as a conventional hardware address, however, according to the invention, there exists no longer a physical port in the branch exchange, which is allocated to this hardware address. If upon setup of a connection, such a pseudo hardware address is determined, the connection will be set up over any other gateway of the branch exchange. Preferably, the gateway (VoIP board) over which the calling terminal (if the latter is also an IP terminal) sets up the connection will be used. If this is not possible because that gateway does not have any spare traffic-handling capacities, the connection will be set up over another gateway, preferably the one with the lowest capacity utilisation.

The method according to the invention for setting up an IP telephony connection between an original terminal and a destination terminal among several terminals in an IP network through one of several gateways of a branch exchange comprises the following steps: setting up a connection between the original terminal and a first gateway, the original terminal selecting the first gateway from several gateways by means of a list of IP addresses, setting up a connection between the original terminal and a first gateway, the original terminal selecting the first gateway from the several gateways by means of a list of IP addresses, verification whether the first gateway has any spare traffic-handling capacities and, if the first gateway has spare traffic-handling capacities, setting up a connection between the first gateway and the destination terminal. Preferably, if the first gateway is found not to have any spare traffic-handling capacities, a second gateway of the branch exchange with spare traffic-handling is selected, a connection between the first gateway and the second gateway through a system control of the branch exchange is set up, and a connection between the second gateway and the destination terminal is set up.

In other words, the gateways used for establishing the contact between the terminals are selected in view of availability or capacity aspects. If possible in view of these aspects, the first gateway, to which contact from the original terminal is made using the list of IP addresses, is also used for establishing contact to the destination terminal, thus establishing a communication channel requiring one gateway only. If due to capacity aspects this is not possible, an appropriate second gateway is selected for establishing the communication channel to the destination terminal.

Preferably, the method possesses one or several of the following features individually or in combination:

determination and definition of the second gateway comprises: verification whether the first gateway has any spare traffic-handling capacities and definition of the first gateway as being at the same time the second gateway, if the first gateway has spare traffic-handling capacities, so that the connection between the first gateway and the second gateway is a gateway-internal connection, and search for a gateway with spare traffic-handling capacities, and definition of the gateway as being the second gateway, if the first gateway does not have any spare traffic-handling capacities;

determination of the IP address of the original terminal and the destination terminal and respective conversion into a pseudo hardware address as a function of the gateway, and connection of an input and an output in a switching matrix in the system control in accordance with the pseudo hardware address of the original terminal and the destination terminal, respectively;

the IP address is converted into a pseudo hardware address through a data-flow control unit in the system control, and spare traffic-handling capacities of the (first and) second gateways are determined through a call control;

the pseudo hardware address has the same format as a conventional hardware address (the pseudo hardware address can be distinguished from conventional hardware address e.g. by using value areas reserved for it);

the pseudo hardware address is transmitted to the call control as being the sender's address and through it, configuration data of the original terminal are registered by the call control.

The system control according to the invention in a branch exchange for setting up an IP-telephony connection between an original terminal and a destination terminal among several terminals in an IP network, over one of several gateways of a branch exchange comprises: a data-flow control unit for converting the IP address of an original terminal or a destination terminal, respectively, into a pseudo hardware address, and a call control for determining a gateway of the branch exchange having spare traffic-handling capacities, and for connecting an input with an output in a switching matrix as a function of the pseudo hardware address of the original terminal and the destination terminal and of the gateway, for the duration of the connection.

In particular, the data-flow control comprises an MSC address table with an allocation between IP address and pseudo hardware address, the pseudo hardware address having the same format as a conventional hardware address.

The application of the invention offers, among others, the following advantages. As, according to the invention, the gateway (VoIP board) is allocated to the IP terminal (IP phone) for the duration of one connection only, each gateway (VoIP board) can now be used for each IP terminal (IP phone) so that the availability of each IP terminal (IP phone) in the total system is increased.

The method according to the invention is not limited to branch exchanges with several gateways (VoIP boards). That means that it is not necessary to have two different implementations of a branch exchange, one of them enabling the operation of a branch exchange with several gateways (VoIP boards) and the other, the operation of a branch exchange with a single gateway (VoIP board).

In addition to the advantage that no transcoding operations are necessary (this applies to the use of different Codecs or the capacity utilisation of a VoIP board and to the improvement of the voice quality (QoS: Quality of Service)), the availability of the overall system for each IP terminal (IP phone) is increased. The switching software can remain almost unchanged, only slight modifications have to be carried out on the VoIP boards for implementing the invention.

Further advantages and features of the invention will become evident from the following description of preferred embodiments, with reference to the enclosed drawings.

### BRIEF DESCRIPTION OF THE DRAWINGS

FIG. 1 shows a branch exchange on an IP network with several terminals according to the state of the art for a first communication path.

FIG. 2 shows a branch exchange on an IP network with several terminals according to the state of the art for a second communication path.

FIG. 3 shows a branch exchange according to the invention on an IP network with several terminals for a third communication path.

FIG. 4 shows a branch exchange according to the invention on an IP network with several terminals for a fourth communication path.

### DETAILED DESCRIPTION

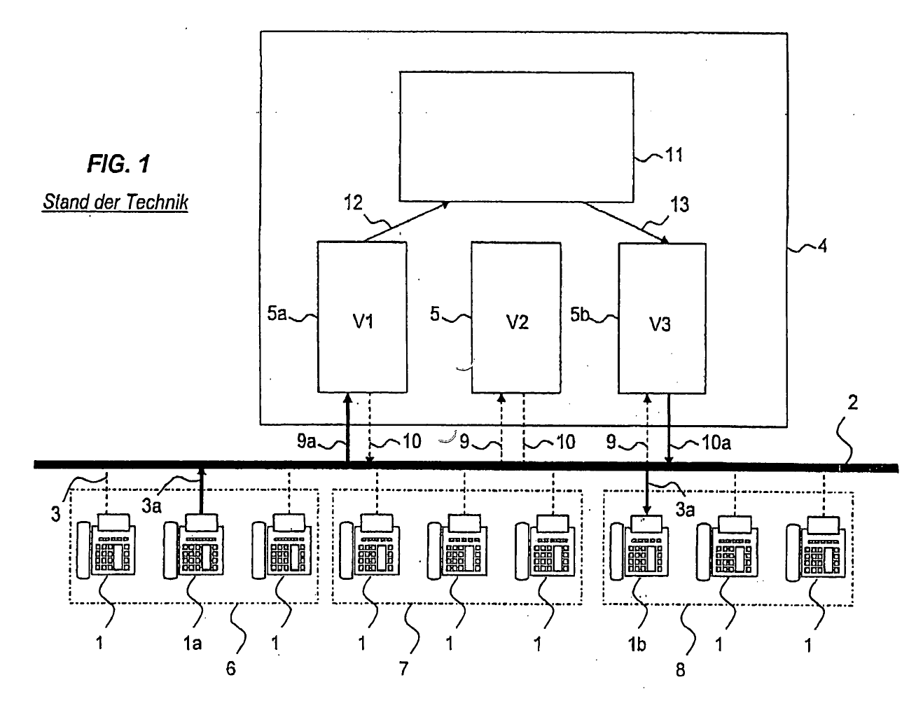

FIG. 1 shows the structure of an IP network with several terminals 1 on an LAN 2 with which they are connected through connection lines 3. In the figures, connections are in general represented in dotted lines, whereas active connections are represented in continuous lines, and their reference number has always the supplement “a”.

The terminals 1 are connected to a branch exchange 4 comprising several gateways (VoIP assemblies or VoIP boards) 5. Each gateway 5 is adapted for a group of terminals. The gateway 5 V1, for example, is adapted for the terminals 1 combined in a first group 6, the gateway 5 V2 is adapted for the terminals 1 combined in a second group 7, and the gateway 5 V3 is adapted for the terminals 1 combined in a third group 8.

As to the IP terminals 1 of the first group 6, the IP address of the gateway 5 V1 is stored in the individual IP terminals 1 of the first group 6. Equally, concerning the IP terminals 1 of the second group 7, the IP address of the gateway 5 V2 is stored in the individual IP terminals 1 of the second group 7 and, concerning the IP terminals 1 of the third group 8, the IP address of the gateway 5 V3 is stored in the individual IP terminals 1 of the third group 8. Each of the gateways 5 possesses a fixed number of switchable channels 9 or 10, channel 9 being the one in which the gateway 5 is the gateway of the original terminal 1 a (gateway upstream from the terminal) and channel 10 being the one in which gateway 5 is the gateway of the destination terminal (terminal upstream from the gateway). Each of these channels has a fixed hardware address, as seen by the branch exchange.

FIG. 1 shows a first communication process in which the original terminal 1a dials the directory number of a destination terminal 1b, which belongs to another group of terminals, in the example shown, to group 8. First, over the IP address stored in the original terminal 1a, the connection 3a, 9a to the gateway 5a V1 is set up, and from there, over a channel 12, to a call-control software containing a switching matrix 11. The call control determines the hardware address associated with the dialed directory number of the destination terminal 1b. This hardware address leads to the gateway 5b and through the connection 10a, 3a, to the terminal 1b. As the connection is switched over two different gateways, the data flow (media stream) must be switched over the switching matrix 11 of the branch exchange 4, i.e., there are two transcoding operations, namely from IP coding to IDSN coding and vice versa, from ISDN coding to IP coding. In the switching matrix 11, incoming and outgoing lines or channels are connected with each other in conformity with control data.

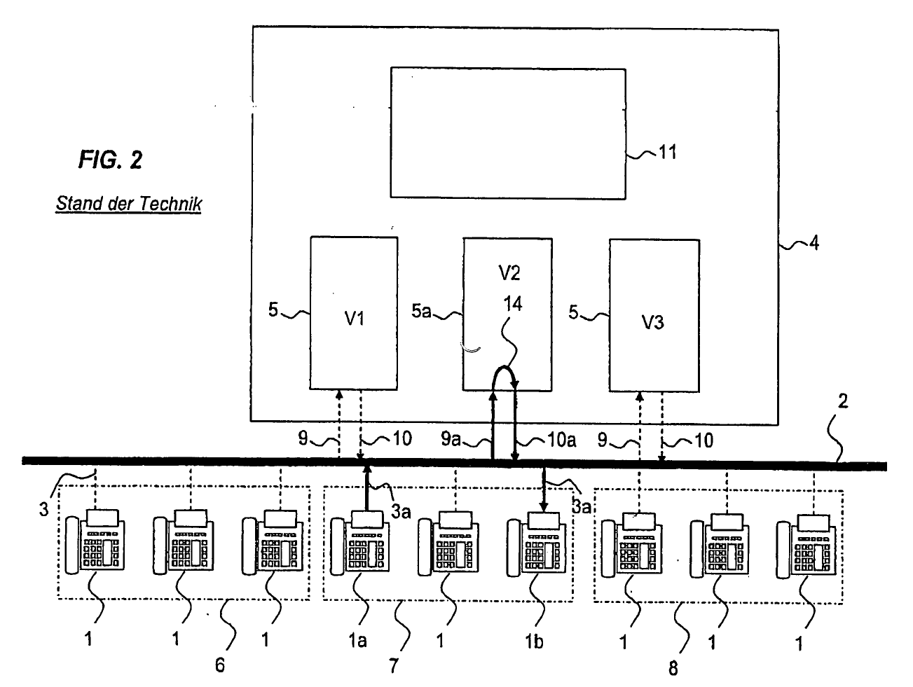

FIG. 2 shows the layout according to FIG. 1 for the case that the two terminals 1a and 1b communicating with each other are connected to the same gateway 5a. Identical components as in FIG. 1 are marked with the same reference numbers as in FIG. 1. When the two involved terminals 1a and 1b belong to the same group (in this case, 7) and are, therefore, supplied by the same gateway 5a, it is not necessary to transmit the data from the gateway 5 to the call-control software and to store the call parameters. In this case, the entire voice/data traffic can be regulated in the gateway 5a, which is the only one involved in the communication connection, so that only an internal routing onward from port 9a to port 10a over an internal lop 14 is necessary. Therefore, in this case, no transcoding is necessary at all. It has to be noted, however, that such a constellation will only occur in a fraction of all possible cases, if the branch exchange 4 possesses more than one gateway 5. In the state of the art shown in FIG. 1 and FIG. 2, there are practically rigid tunnels between one gateway 5 and the IP terminals 1 allocated to it. As soon as two IP terminals 1 involved in a connection are allocated to different gateways 5, the data flow has to be directed over the switching matrix 11 of the branch exchange, so that two transcoding operations become necessary.

Although the relation between the number of IP terminals (IP phones) 1 allocated to one gateway 5 and the connection capacity of the gateway 5 is the result of traffic-theoretical computations, the IP terminals 1 according to this state of the art are often unable, in case of load, to set up connections or cannot be reached by others, whereas at the same time other gateways 5 of the same branch exchange 4 might not be fully utilised.

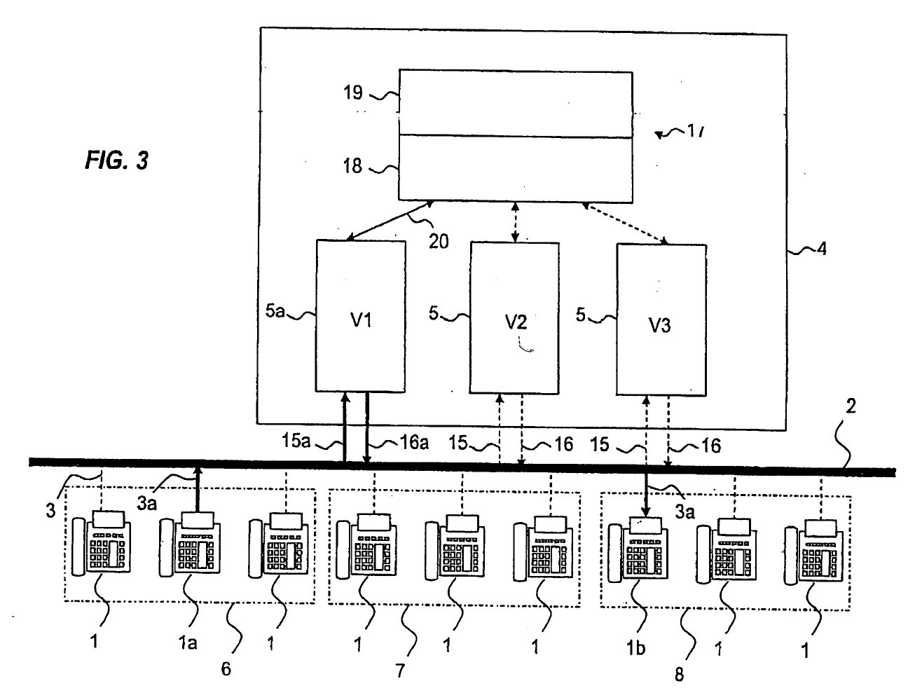

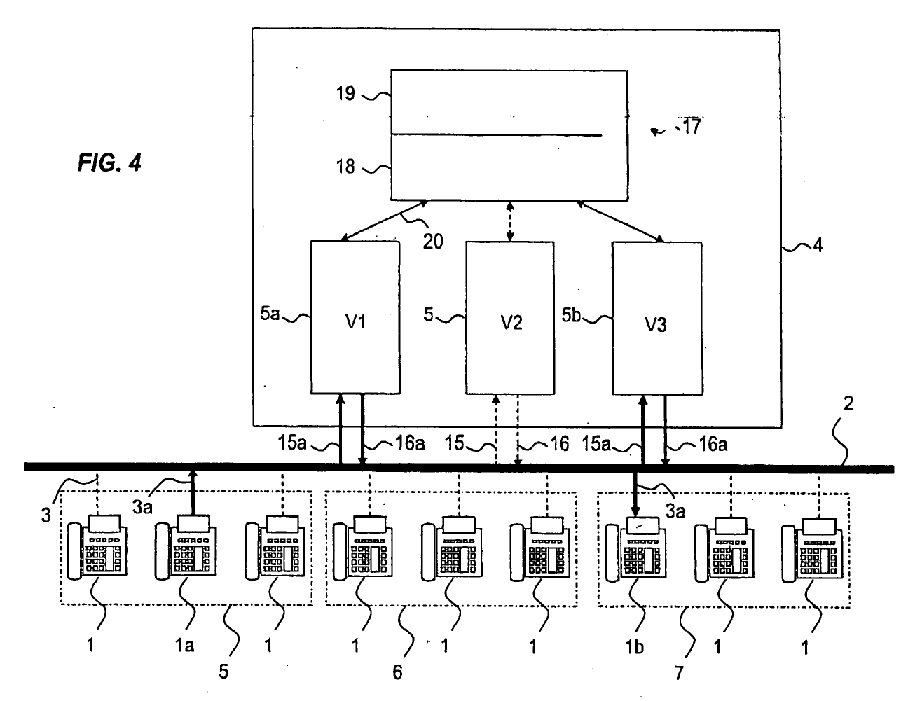

The following is a description of the method according to the invention with reference to FIGS. 3 and 4.

According to the invention, a list of the IP addresses of the gateways 5 of the branch exchange 4 is stored in each IP terminal 1. A subdivision of the terminals 1 into groups 6, 7, 8 as well as the rigid allocation of one gateway 5 to each of these groups is, therefore, no longer necessary with the invention, because every terminal 1 can access every gateway 5 through the latter's IP address. The setup of a connection will in the following be described with reference to the example shown in FIG. 3, in which the original terminal 1a sets up the connection over the gateway 5a. The original terminal 1a dials the directory number of the destination terminal 1b. First, the gateway 5a is selected by means of the IP address list stored in the original terminal 1a, the connection to the gateway 5a is set up and, from there, over a bidirectional connection 20, routed onward to a system control 17. The system control 17 consists of the call-control software 19 and a data-flow control 18, which according to the invention represents a new functional unit (media-stream control, MSC).

The IP address of the original terminal 1a is transmitted to the data-flow control MSC 18 and is translated there, over an MSC address table, into the pseudo hardware address allocated to the original terminal 1 a. This pseudo hardware address has the same format as a conventional hardware address, but there exists no physical port in the branch exchange associated with this hardware address.

The following Table 1 is an example for an MSC address table.

TABLE 1

| IP address | (Pseudo) hardware address |
|---|---|
| 123.456.789.11 | HWA1 |
| 123.456.789.12 | HWA2 |
| 123.456.789.13 | HWA3 |
| 123.456.789.14 | HWA4 |
| 123.456.789.15 | HWA5 |
| 123.456.789.16 | HWA6 |
| 123.456.789.17 | HWA7 |
| 123.456.789.18 | HWA8 |
| 123.456.789.19 | HWA9 |

The left-hand column contains the IP addresses, and in the right-handed column, the associated pseudo hardware addresses are listed.

The pseudo hardware address of the original terminal 1a is transmitted in a setup message (first connection-setup message) as the sender's address to the call control 19. Over the pseudo hardware address, the call control 19 can read the configuration data of the original terminal 1a, like in the case of a conventional hardware address.

From the directory-number plan, in which each directory number of an IP terminal 1 is allocated a pseudo hardware address, the hardware address associated with the dialed directory number of the destination terminal 1b is determined. If this address is, like in this example, a pseudo hardware address, the going setup is not transmitted to an assembly, but to the data-flow control MSC 18.

The following Table 2 is an example for a directory-number plan.

TABLE 2

| Directory number | (Pseudo) hardware address |
|---|---|
| 4711 (first terminal of group 6) | HWA1 |
| 4712 (second terminal of group 6) | HWA2 |
| 4713 (third terminal of group 6) | HWA3 |
| 5030 (first terminal of group 7) | HWA4 |
| 5191 (second terminal of group 7) | HWA5 |
| 5274 (third terminal of group 7) | HWA6 |
| 6123 (first terminal of group 8) | HWA7 |
| 5456 (second terminal of group 8) | HWA8 |
| 5789 (third terminal of group 8) | HWA9 |

The left-hand column of Table 2 contains the directory numbers of the first, second, third terminals 1 of group 6, of the first, second, third terminals 1 of group 7, and of the first, second, third terminals 1 of group 8, in the right-hand column, the associated pseudo hardware addresses are indicated.

The data-flow control MSC 18 can determine, with the help of Table 1 and a gateway allocation table (Table 4) described below, by means of the sender's pseudo hardware address of the original terminal 1a, the allocated gateway 5a, and can determine, with the help of a gateway load table (Table 3) described below, whether the gateway 5a still has some free (switchable) channels.

The following Table 3 is an example for the gateway load table in the data-flow control MSC 18.

TABLE 3

| Gateway | Available channels | Free channels |
|---|---|---|
| V1 | 30 | 20 |
| V2 | 30 | 24 |
| V3 | 30 | 10 |

For each gateway 5, the number of free channels and—preferably—the number of available channels is listed.

The following Table 4 is an example for a gateway allocation table in the data-flow control MSC 18.

TABLE 4

| IP address | Gateway |
|---|---|
| 123.456.789.11 | V1 |
| 123.456.789.12 | V1 |
| 123.456.789.13 | V1 |
| 123.456.789.14 | V2 |
| 123.456.789.15 | V2 |
| 123.456.789.16 | V2 |
| 123.456.789.17 | V3 |
| 123.456.789.18 | V3 |
| 123.456.789.19 | V3 |

For each IP address, a gateway 5 is listed, whereby, of course, the allocation need not necessarily be reversibly unambiguous.

By means of the above tables, the data-flow control MSC 18 can determine whether the gateway 5a has free (switchable) channels. If so, the setup message will be passed on to the gateway 5a, if not, it will be determined by means of the same table which gateway 5 has the lowest load, i.e. the largest number of free channels. The setup message will then be sent to that gateway. In the example in Table 3 and in FIG. 3, the gateway 5a has a total of 30 available channels, 20 of which are still free. In order to avoid, as explained above, a double transcoding, the connection between the branch exchange 4 and the destination terminal 1b is, therefore, handled over this gateway 5a, as it has enough spare capacities. Only after the gateway 5a is completely utilized, will an alternative gateway be searched. The setup message sent to the gateway 5a contains the IP address of the destination terminal 1b, which is determined by the MSC by means of the pseudo hardware address of destination (1b) (see Table 1). The gateway 5b sets up the connection to the terminal 1b with this IP address.

In another example, shown in FIG. 4, the capacity of the gateway 5a selected by the original terminal 1a is fully utilized. Therefore, it rejects the inquiry of the system control 17 for setup of a connection. The system control 17 starts further attempts to other gateways 5. In the example shown in FIG. 4, the gateway 5b has the lowest load, i.e. the largest number of free channels. Accordingly, the setup message is sent to this gateway.

If the capacity of all gateways 5 is fully utilized, the connection setup will be interrupted. Otherwise, the connection will be setup over the first available gateway found, in the above-described way.

Thus, to increase the availability of the overall system for each IP terminal and to enhance in this way the voice quality of the IP-telephony connection, the setup of a connection between the original terminal and a first gateway is effected, according to the invention, by means of a list of IP addresses, a connection between the first gateway and a second gateway is set up by a system control of the branch exchange, and a connection between the second gateway and the destination terminal is effected by the second gateway, the setup of the connection between the first gateway and the second gateway by the system control comprising the determination of a gateway with spare traffic-handling capacities among the several gateways of the branch exchange and the definition of this gateway as being the second gateway.

### REFERENCE NUMERALS

1 IP terminal
2 IP network (LAN)
3 Connection of IP terminal with LAN
4 Branch exchange
5 Gateway in branch exchange, 5a and 5b active gateways
6 First group of IP terminals
7 Second group of IP terminals
8 Third group of IP terminals
9 Hardware connection IP terminal—gateway, 9a active hardware connection
10 Hardware connection gateway—IP terminal, 10a active hardware connection
11 Switching matrix
12 Link “input” of gateway with switching matrix
13 Link “output” of gateway with switching matrix
14 Internal loop in gateway without transcoding
15 Pseudo hardware connection original terminal—gateway, 15a active pseudo hardware connection
16 Pseudo hardware connection gateway—original terminal, 15a active pseudo hardware connection
17 System control
18 Data-flow control
19 Call control
20 Bidirectional connection gateway—data-flow control

A number of variations and modifications of the invention can be used. It would be possible to provide for some features of the invention without providing others.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. Method for the setup of an IP telephony connection between an original terminal and a destination terminal among several terminals in an IP network over one of several gateways of a branch exchange with the steps:
setting up a connection between the original terminal and a first gateway, the original terminal selecting the first gateway from the several gateways by means of a list of IP addresses;
verification whether the first gateway has any spare traffic-handling capacities and, if the first gateway has spare traffic-handling capacities;
setting up a connection between the first gateway and the destination terminal.

2. Method according to claim 1, with the further steps:
if the first gateway is found not to have any spare traffic-handling capacities, searching for a second gateway of the branch exchange with spare traffic-handling;
setting up a connection between the first gateway and the second gateway (through a system control of the branch exchange; and
setting up a connection between the second gateway and the destination terminal.

3. Method according to claim 1, with the steps:
determination of the IP address of the original terminal and the destination terminal and respective conversion into a pseudo hardware address as a function of the gateway; and
connection of an input and an output in a switching matrix in the system control in accordance with the pseudo hardware address of the original terminal or the destination terminal.

4. Method according to claim 3, in which
the IP address is converted into a pseudo hardware address through a data-flow control unit in the system control; and
spare traffic-handling capacities of the first and second gateways are determined by a call control.

5. Method according to claim 3, in which
the pseudo hardware address is transmitted to the call control as the sender's address and, over it, configuration data of the original terminal are registered by the call control.

6. Method according to claim 3, in which
the pseudo hardware address is transmitted to the call control as the sender's address and, over it, configuration data or the original terminal are registered by the call control.

7. System control in a branch exchange for setting up an IP telephony connection between an original terminal and a destination terminal among several terminals in an IP network over one of several gateways of a branch exchange (4), which comprises:
a data flow control unit (18) for converting the IP address of an original terminal or a destination terminal, respectively, into a pseudo hardware address, and
a call control for determining a gateway of the branch exchange with spare traffic-handling capacities and for connecting an input with an output in a switching matrix as a function of the pseudo hardware address of the original terminal and the destination terminal and of the gateway for the duration of the connection.

8. System control according to claim 7, in which
the data-flow control comprises an MSC address table with an allocation between IP address and pseudo hardware address, the pseudo hardware address having the same format as a conventional hardware address.

9. Method according to claim 2, with the steps:
determination of the IP address of the original terminal and the destination terminal and respective conversation into a pseudo hardware address as a function of the gateway; and
connection of an input and an output in a switching matrix in the system control in accordance with the pseudo hardware address of the original terminal or the destination terminal.

10. Method according to claim 9, in which
the IP address is converted into a pseudo hardware address through a data-flow control unit in the system control; and
spare traffic-handling capacities of the first and second gateways are determined by a call control.

11. Method according to claim 3, in which
the pseudo hardware address has the same format as a conventional hardware address.

12. Method according to claim 9, in which
the pseudo hardware address has the same format as a conventional hardware address.

13. Method according to claim 9, in which
the pseudo hardware address is transmitted to the call control as the sender's address and, over it, configuration data of the original terminal are registered by the call control.

14. Method according to claim 4, in which
the pseudo hardware address is transmitted to the call control as the sender's address and, over it, configuration data of the original terminal are registered by the call control.

15. Method according to claim 10, in which
the pseudo hardware address is transmitted to the call control as the sender's address and, over it, configuration data of the original terminal are registered by the call control.

16. Method according to claim 5, in which
the pseudo hardware address is transmitted to the call control as the sender's address and, over it, configuration data of the original terminal are registered by the call control.

17. Method according to claim 11, in which
the pseudo hardware address is transmitted to the call control as the sender's address and, over it, configuration data of the original terminal are registered by the call control.
